(19) United States
(12) Patent Application Publication
(10) Pub. No.: US 2002/0118886 A1
(43) Pub. Date: Aug. 29, 2002

(54) Video transmission and receiving method and apparatus using radio communication instrument

(76) Inventors: Hoon Hwang, Keongki-Do (KR); Gil-rak Lee, Keongki-Do (KR)

Correspondence Address: MERCHANT & GOULD PC, P.O. BOX 2903, MINNEAPOLIS, MN, 55402-0903, US

(21) Appl. No.: 09/747,156

(22) Filed: Dec. 21, 2000

(30) Foreign Application Priority Data
Dec. 13, 2000 (KR) 2000-75721

(51) Int. Cl. G06K 9/36

(52) U.S. Cl. 382/250

(57) ABSTRACT

The present invention relates to a video transmission and receiving method and apparatus using a radio communication instrument which are capable of transferring and receiving various information such as a video signal using a conventional radio communication instrument without providing an additional apparatus. The radio transmission and receiving apparatus using a radio communication instrument includes an input unit for receiving a video signal generated by a video input apparatus such as a video camera, etc., a capture and analog/digital converter for capturing the inputted video signal by a field or frame and converting into a digital signal, a storing unit for temporarily storing the converted digital video data, a central processing unit for JPEG-compressing the stored digital video data by a horizontal line, changing a transmission sequence of the JPEG compressed data based on a certain method, encrypting the same and performing a decompression and decoding operation with respect to an externally received compressed and encrypted video signal, an encryption code generator including a variation table by which the central processing unit changes a transmission sequence of the JPEG-compressed data in a transmission mode and the sequence of the data of the signal having a changed sequence is recovered in a receiving mode, and a display unit for displaying a video signal which is currently inputted or received.

### BACKGROUND OF THE INVENTION

1. Field of the Invention

The present invention relates to a video transmission and receiving method and apparatus, and in particular to a video transmission and receiving method and apparatus capable of transmitting a still and motion picture using a conventional radio communication instrument, namely, a radio unit.

2. Description of the Background Art

In an advanced modern society, the use of a radio communication instrument, namely, a radio unit capable of transferring an audio signal to a remote region is diversified. The radio communication instrument is generally used in a security company, a construction company, a large size distribution company, etc. In addition, the number of persons who work for an amateur radio communication is increased, so that the use of the radio communication apparatus becomes an essential factor in the advanced modern society.

The radio communication instrument, so called a radio unit, is an apparatus capable of directly transferring an audio signal to a receiving side in an electronic wave form or transferring and receiving an audio signal by reflecting the audio signal to an ionized layer or a communication satellite. In the above radio communication, an information is carried on a carrier by a modulation process, namely, a process in which the amplitude, frequency, phase, etc. of the carrier is varied by an original signal. The amplitude modulation(AM) is a modulation method capable of varying the amplitude of the carrier based on a wave form of a signal. In this method, the intensity of the wave is modulated based on a sideband frequency at the maximum and minimum levels of the carrier for thereby transferring the information. An envelope of the wave which is modulated becomes a wave form similar with the signal wave form. In this process, only the amplitude is varied, and the frequency is not varied. In the frequency modulation(FM), an information is transmitted from a transmitter to a receiving unit by varying the frequency, not the amplitude A base band signal is corresponded to a deviation of a frequency of a sine carrier for thereby transferring the signal. In this method, even when the amplitude of the signal is varied due to a noise inserted during a transmission, the upper and lower portions of the signal are cut and are inputted into a discriminator for thereby fully recovering an original signal. In addition, a phase modulation method is a modulation method for deviating a phase based on a variation of an input signal with respect to an alternating current signal having a constant frequency and transferring the information based on the amount of the deviation.

In a modern multimedia era, various data such as a still and motion picture and a character are processed. If it is possible to transmit and receive various data such as a still and motion picture including an audio medium using a conventional radio communication instrument, the using range of the same may be sharply increased. For example, a helicopter which detected an illegal fishing boat in the sea may transfer the current state of the illegal fishing activity using a conventional radio communication apparatus based on a video transfer. In addition, in the case of an emergency car, namely, when a human rescue team or a hospital ambulance carries a patient, the current state of a patient may be transferred to a hospital based on a video transfer, so that it is possible to perform an emergency treatment during the transfer of the patient. In addition, in the case of a natural disaster, namely, in the case of a fire, or other disaster, the current state may be transferred based on a video transfer. However, the conventional radio communication instrument has a limit for transmitting and receiving various signals such as a video signal.

### SUMMARY OF THE INVENTION

Accordingly, it is an object of the present invention to provide a video transmission and receiving method and apparatus using a radio communication instrument which are capable of transferring and receiving various information such as a video signal using a conventional radio communication instrument without providing an additional apparatus.

To achieve the above objects, there is provided an improved radio transmission and receiving apparatus using a radio communication instrument which includes an input unit for receiving a video signal generated by a video input apparatus such as a video camera, etc., a capture and analog/digital converter for capturing the inputted video signal by a field or frame and converting into a digital signal, a storing unit for temporarily storing the converted digital video data, a central processing unit for JPEG-compressing the stored digital video data by a horizontal line, changing a transmission sequence of the JPEG compressed data based on a certain method, encrypting the same and performing a decompression and decoding operation with respect to an externally received compressed and encrypted video signal, an encryption code generator including a variation table by which the central processing unit changes a transmission sequence of the JPEG-compressed data in a transmission mode and the sequence of the data of the signal having a changed sequence is recovered in a receiving mode, a display unit for displaying a video signal which is currently inputted or received, a radio communication instrument controller for transferring a compressed and encrypted video data by the central processing unit to the radio communication instrument or transferring the video data received from the radio communication instrument to the central processing apparatus, a controller for connecting the central processing unit to the display unit and radio communication instrument controller in accordance with a transmission and receiving state of the video data and controlling the movement of the video data, and a power management unit for supplying a voltage and current to each element so that the video transmission and receiving apparatus is normally operated.

A computer connection unit is further provided for controlling and managing the function and operation of the video transmission and receiving apparatus based on a unmanned or remote method.

An option unit is further provided for diversifying and maximizing the functions of the video transmission and receiving apparatus.

A security connector is further provided for transmitting a video signal in a security format.

The video transmission and receiving apparatus is connected by a connection apparatus separately from the radio communication instrument.

The video transmission and receiving apparatus is used integrally with the radio communication instrument.

To achieve the above object, there is provided an improved video signal compression method of a video transmission and receiving apparatus which includes a step for storing an inputted digital video data into a storing unit by the unit of a field or frame, a step for computing the stored video data by a horizontal line of the field or frame, JPEG-compressing the number of the lines as one unit and storing the compressed data into another storing unit, and a step for forming a process that a digital video data is JPEG-compressed and stored into a memory region as a loop and performing the loop until all line data in the selected field or frame are JPEG-compressed.

The JPEG compression is performed by a first irregular function generation routine, and the first irregular function generation routine includes a step for sequentially or randomly varying a certain group of numeral digits at a certain speed, a step for selecting a certain numeral digit from the group of the numeral digits when transferring a video through the video transmission and receiving apparatus, and a step in which the number of the horizontal lines of the JPEG-compressed field or frame is determined based on a selected numeral digit.

A method for encrypting a JPEG-compressed signal in a video transmission and receiving apparatus includes a step for storing the JPEG compressed data into a storing unit by the field or frame in a sequence that the data is compressed and providing a serial number to each compression data, a step for randomly a serial number of the compression data, and a step for transferring a JPEG-compressed video data in accordance with a sequence of the changed serial number.

The step for changing the serial number of the compression data includes a step for forming a plurality of code variation tables having a serial number of the compressed data and a changed number corresponding to the serial number based on 1:1, a step for randomly selecting one among the variation tables the video data is transmitted and a step for changing the sequence of the data compressed in a sequence that the data is formed in a corresponding table when selecting one among the variation tables.

A signal format used when transferring and receiving a video signal using a radio communication instrument includes a code for indicating a transmission start of a video data as a header of a signal format, a code for indicating a variations state of a JPEG compression data, a code for indicating a JPEG compression method, a compression video data, a code for indicating a data of other function, and a recognizing code for indicating a completion of a video signal transmission.

### BRIEF DESCRIPTION OF THE DRAWINGS

The present invention will become better understood with reference to the accompanying drawings. which are given only by way of illustration and thus are not limitative of the present invention, wherein;

FIG. 1 is a view illustrating a construction that a video transmitting and receiving apparatus is connected with a conventional radio communication instrument.

FIG. 2 is a view illustrating the construction of a video transmission and receiving apparatus using a radio communication instrument according to the present invention.

FIG. 3A and 3B are views illustrating the concept of video signal compression(JPEG) processes according to the present invention.

FIG. 4 is a view illustrating the concept of encryption processes of the JPEG data according to the present invention.

FIG. 5 is a view illustrating data format according to the present invention.

### DETAILED DESCRIPTION OF THE PREFERRED EMBODIMENTS

The embodiments of the present invention will be explained with reference to the accompanying drawings.

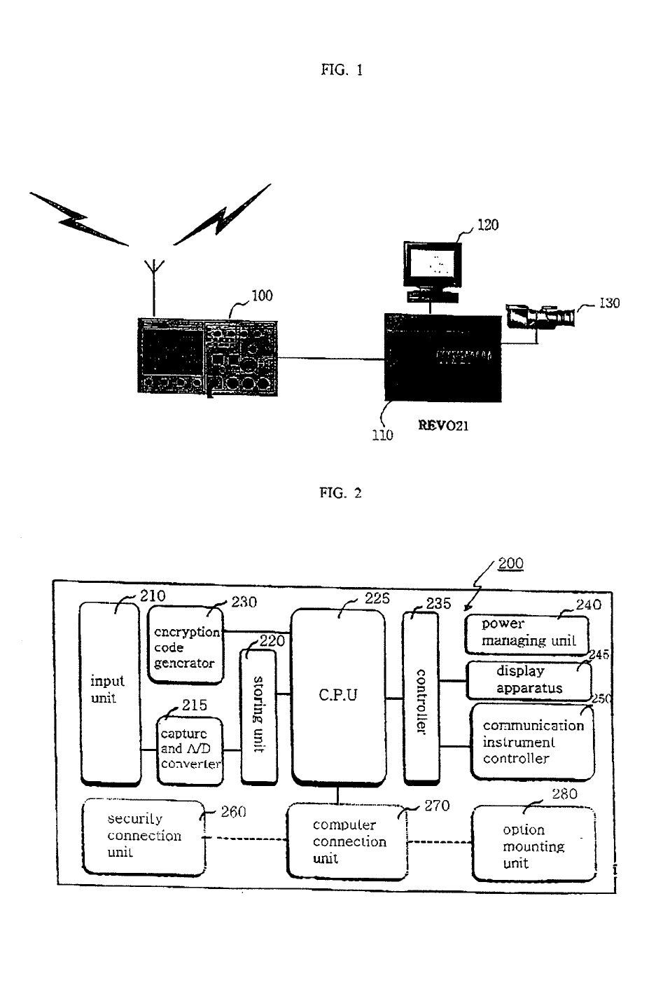

The video transmitting and receiving apparatus according to the present invention may be integrated with a radio communication instrument or may be connected with a conventional separated radio communication instrument. FIG. 1 is a view illustrating a construction that a video transmitting and receiving apparatus is connected with a conventional radio communication instrument. In the drawings, reference numeral 100 represents a conventional radio communication instrument. The radio communication instrument 100 is connected with a video transmission and receiving apparatus 110. The video transmission and receiving apparatus 110 is connected with a video input apparatus 130 for providing a video signal, and a monitor 100 for displaying a video inputted from the video input apparatus 130 and a video signal received from the radio communication instrument 100 by the video transmission and receiving apparatus 110. The video input apparatus may use a built-in camera or may be connected with an external video camera.

When transferring a video using a video transmitting and receiving apparatus according to the present invention, a video which will be transferred is inputted using a video input apparatus of a built-in camera or an external camera. At this time, the inputted video is displayed on a monitor connected with the video transmission and receiving apparatus. So, a user selects a transmission screen and checks the same while viewing a screen of the monitor. Thereafter, the user transmits a video by pressing a video transmission selection button installed in a video transmission and receiving apparatus according to the present invention. A this time, the video signal is compressed in the video transmission and receiving apparatus and is encrypted and is transferred to a radio communication instrument. The radio communication instrument transfers the encrypted signal based of a radio method. The above compression and encrypting method are key features of the present invention. Namely, it is possible to decrease time required for transmitting and receiving a video signal using the conventional radio communication instrument and implementing a security of the communication. The process in which the inputted video signal is compressed and encrypted by the video transmission and receiving apparatus will be explained later.

The method for receiving a video signal through the video transmission and receiving apparatus according to the present invention is implemented by a reverse procedure of the above-described video transmission method. Namely, When the video signal transferred from a remote region is transferred to the conventional radio communication instrument 100, the video signal is transferred to an input unit of the video transmission and receiving apparatus. At this time, the video transmission and receiving apparatus 110 decompresses the video signal and decrypts the encrypted video signal for thereby displaying on the monitor.

FIG. 2 is a view illustrating the construction of a video transmission and receiving apparatus using a radio communication instrument according to the present invention. The case that the video transmission and receiving apparatus is used for the purpose of the transmission will be explained. The video transmission and receiving apparatus indudes an input unit 210 for receiving a video signal from the video input apparatus. The input unit receives a video signal output from a video camera or a built-in camera. The inputted video signal is transferred to a video capture and analog/digital converter 216 of the next circuit block. The inputted video signal is captured by one field or one frame by a selection of a user. Thereafter, the converted video signal is temporarily stored in a storing unit 220 of the next circuit block.

A central processing unit 225 is a unit for performing a brain function of a video transmission and receiving apparatus and manages a flow of all signals in the interior of the system and controls data. The central processing unit 225 compresses a digital video data stored in the storing unit 220 by a built-in compression algorithm. At this time, the compression method is a JPEG compression method. The compression is performed by a special algorithm for preventing a wiretap during the transmission

The central processing unit 225 is connected with an encrypting code generator 230. The JPEG-compressed data is encrypted using a code stored in the encrypting code generator. The security of the communication is obtained by an encryption of the video data, so that it is impossible to reproduce an original video by a wiretapping person even when the data is wiretapped through the radio communication instrument.

The rear end of the central processing unit 225 is connected with a controller 235 for thereby controlling the connections of a power managing apparatus, a display apparatus and a communication instrument controller. When a video signal is inputted from a video input apparatus through the input unit 210, the controller 235 transfers the video signal from the central processing unit 225 to the display unit 245, so that a user views the state of a video received from the current video transmission and receiving apparatus. In addition, When a video signal is externally inputted, the central processing unit 225 transfers a decompressed and decoded video signal to the display apparatus for thereby viewing the received video. The controller 235 transfers a compressed and encrypted video signal from the central processing unit 225 to the radio communication instrument controller 250 during the video transmission for thereby externally transmitting the video signal. In the reversed procedure, the video signal which is compressed and encrypted is transferred from the controller to the central processing unit 225.

The radio communication instrument controller 250 is a unit for inter-working the video transmission and receiving apparatus and the radio communication instrument for thereby controlling a video signal transmission and receiving operation. Namely, when the video signal is transmitted through the video transmission and receiving apparatus according to the present invention, a video signal is not externally inputted. At this time, the video signal inputted from the radio communication instrument controller is temporarily stored or a video signal is received through a certain route, separately from the transmission route, for thereby storing the video signal into the memory.

The video transmission and receiving apparatus 200 includes a power management unit 240 for thereby controlling the voltage and current to correspond with each element, so that all functions of the apparatus 200 is normally operated.

The video transmission and receiving apparatus 200 according to the present invention is connected with a computer connection apparatus 270 for thereby remotely controlling and managing the apparatus by connecting with a computer. The computer connection apparatus 270 is connected with an option mounting apparatus 280, so that it is possible to install an option apparatus for diversifying and maximizing the functions of the apparatus according to the present invention. For example, a scanner may be connected for scanning the still picture such as a photo.

The computer connection apparatus is connected with a security connection apparatus 260 for thereby providing a security to an information transferred and received through a computer and an information transferred through the option mounting apparatus 280. A security algorithm by the security connection apparatus is performed by an algorithm separately from a video signal compression and encryption operation.

A video signal compression and an encryption method with respect to the compressed data according to the present invention will be explained.

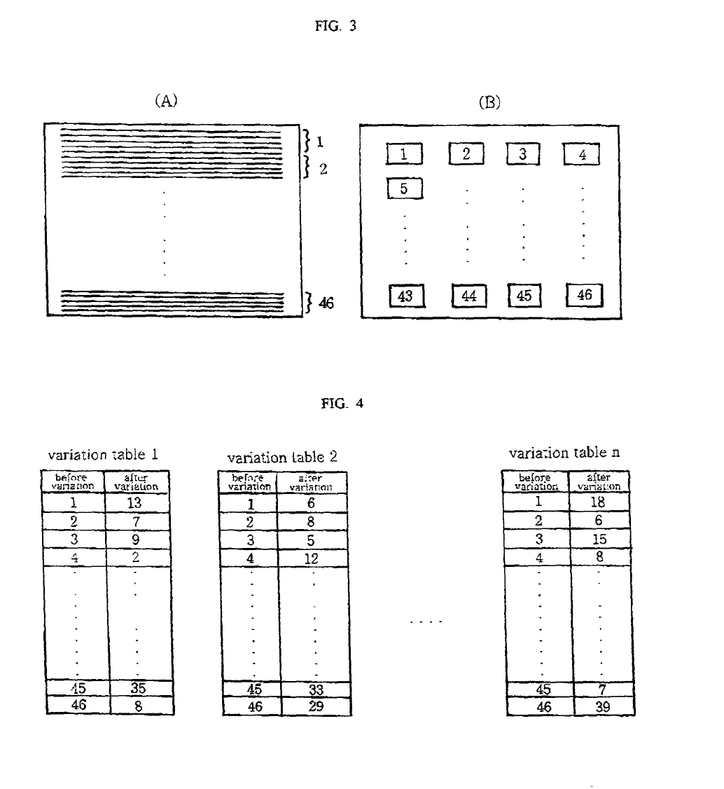

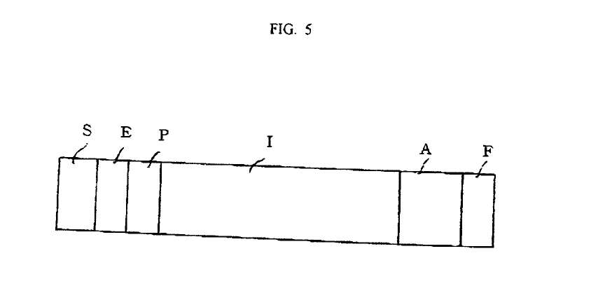

First, the video signal compression(JPEG) will be explained. A video signal inputted into the input unit 210 of the video transmission and receiving apparatus 200 is captured by a field or frame and is processed based on an analog/digital(A/D) conversion and then is stored into the storing unit 220. The stored digital video data is compressed by the JPEG compression method. The above compression method is performed in accordance with a line-based compression method and an independent protocol method. As shown in FIG. 3A, in a state that the digital video signal is stored in the storing unit 220, the number of horizontal lines of the video signals is counted and compressed based on the JPEG compression method, for example, by the unit of five lines. The thusly compressed data are stored in a memory region. The process for JPEG-compressing the horizontal lines and storing into the memory region forms a certain loop. The above loop is performed until all digital video data in the storing unit 220 are JPEG-compressed. As shown in FIG. 3A, since there are 230 horizontal lines, the JPEG compression is performed 46 times with respect to one frame, so that all video data in the frames are compressed. At this time, as shown in FIG. 3B, all JPEG-compressed data are newly arranged in the storing unit. Five lines which are determined as the number of the lines when performing the JPEG compression by the horizontal lines are used for example. A certain number of lines may be used as one unit for the JPEG compression.

The number of the lines concurrently compressed as one unit when performing the JPEG compression by the line may be determined by an irregular function generation routine(first irregular function generation routine). For example, it is assumed that numerals from 3 to 9 are sequentially and quickly changed. The above numerals have only one value at a certain moment. If it is assumed that a video transmission button of the video transmission and receiving apparatus is pressed in order for the user to transmit the video signal, the JPEG compression is performed by the unit of the number of the lines corresponding to the selected numeral. Therefore, the user may not recognize the number of the lines which are compressed by one unit. Even when the video signal is intercepted by a certain person by a wiretap during the transmission, if the person does not know the compression algorithm, it is impossible to reproduce the original video signal. When the JPEG compression is finished, the encryption is performed.

The encryption of the compressed JPEG data will be explained Namely, in order to encrypt the data which are JPEG-compressed by a certain unit of lines, the encryption code generator 230 generates a position variation code by the encryption process routine, namely, an irregular function generation routine(second irregular function generation routine) The position variation code is sequentially processed by a code variation table in a certain sequence. Figure illustrates the examples of the above-described process. A serial number is provided with respect to the JPEG compressed data.

Namely, in the case of the code variation table 1, the digital data 1 which is JPEG-compressed by a constant line(five lines of FIG. 3) is changed to 13, and the compressed digital data 2 is changed to 7. The positions of the compressed digital data, namely, 46 compressed digital data with respect to all lines(230 lines in the embodiment of the present invention) in one frame are changed.

In the case of the code variation table 2, the compressed digital data 1 is changed to 6, and the data 2 is changed to 8. Namely, the storing position of the data is changed in a method different from the method of the code variation table 1. Here, the data position represents a sequence or order that the compressed and encrypted video data are transferred through the radio communication instrument.

In the second irregular function generation routine of the encryption code generator, one among the 1 through n number of code variation tables is selected. The above selection algorithm may be implemented in the same manner as the algorithm for selecting the number of lines during a video data compression. Namely, 1 or n are varied in a certain sequence or at a high speed The above numeral digit has one digit for a certain time. When a video transmission is instructed by pressing a transmission button by the user, one among the variation tables is selected. The central processing unit reads a table corresponding to the encryption code generator 230. The position of the JPEG compression data is changed in accordance with the method of the variation table. Therefore, when transmitting the video, the video transmission and receiving apparatus according to the present invention operates the first irregular function generation routine and the second irregular function generation routine for thereby determining the number of lines of the video data which are compressed at one time and determining a certain code variation table for changing the position of the compressed data.

When the video data is transferred through the radio communication instrument, the data is transferred in a state that the transmission sequence of the compressed data is changed in accordance with the position variation table. Since the data is transferred in the changed sequence, even when the transmission video data is intercepted, since the compressed data are mixed, it is impossible to obtain an original video by reproducing the data.

The compressed and encrypted video data is decompressed and decrypted at the receiving side for thereby obtaining an original video. When transferring the video data at the transmission side, the information with respect to the compression and encryption is transferred to the receiving side together with the video data. For implementing the above process, the following method may be used. As shown in FIG. 5, when transferring the video data, a code which represents a data transmission is inserted into the header of the data. When the above code is received at the receiving side, the video data is changed to a mode for a video data receiving and converting operation. Thereafter, the code with respect to the encryption method is transmitted. The above code is a code with respect to the variation table number which represents a state that the transfer sequence of the JPEG compression data is changed. The receiving side has an information with respect to the variation table. Namely, it is possible to know the method that the currently received compression data is rearranged using only the variation table number. Therefore, the receiving side rearrange the video data to an original sequence using the above information.

A code(P) with respect to the JPEG compression method is transferred. This code represents a state that the video data is compressed by a certain unit of lines. When the compression state is recognized by the code, the receiving side decompresses the compressed data for thereby reproducing an original video data.

The rear portion of the code with respect to the JPEG compression method is connected with the video data(I). Thereafter, the data(A) of other functions are attached, and then a recognition code(F) which represents a completion of the format is attached. When the code completion code is received, at the receiving side, it is recognized that all video data with respect to one field or frame is received for thereby storing the video data or reproducing a video. When another video signal is received, the video signal of the following frame or field is received through the above-described procedure for thereby performing the same operation as the above-described operation.

As described above, in the present invention, it is possible to conveniently transfer and receive a still or motion picture using a conventional radio communication apparatus. Therefore, it is possible to transfer and receive the vie signal directly between the video transmitters and receiving units or using an unmanned relay unit, a key communication network, a satellite, etc. The apparatus according to the present invention, may be used for a military facility, namely, it is possible to transfer the current state of an enemy penetration site or a battle site to a related corps. In addition, the apparatus according to the present invention may be used for a public peace using the videos of a cop”s criminal tracing operation and accident site. Furthermore, the apparatus according to the present invention may be used in the case that an emergency state occurs in the hospital ambulance or human rescue team. When a wired network is disconnected due to a natural disaster occurs, the apparatus according to the present invention may be used.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a video transmission and receiving apparatus using a radio communication instrument, an improved radio transmission and receiving apparatus using a radio communication instrument, comprising:
an input unit for receiving a video signal generated by a video input apparatus such as a video camera, etc.;
a capture and analog/digital converter for capturing the inputted video signal by a field or frame and converting into a digital signal;
a storing unit for temporarily storing the converted digital video data;
a central processing unit for JPEG-compressing the stored digital video data by a horizontal line, changing a transmission sequence of the JPEG compressed data based on a certain method, encrypting the same and performing a decompression and decoding operation with respect to an externally received compressed and encrypted video signal;
an encryption code generator including a variation table by which the central processing unit changes a transmission sequence of the JPEG-compressed data in a transmission mode and the sequence of the data of the signal having a changed sequence is recovered in a receiving mode;
a display unit for displaying a video signal which is currently inputted or received;
a radio communication instrument controller for transferring a compressed and encrypted video data by the central processing unit to the radio communication instrument or transferring the video data received from the radio communication instrument to the central processing apparatus;
a controller for connecting the central processing unit to the display unit and radio communication instrument controller in accordance with a transmission and receiving state of the video data and controlling the movement of the video data; and
a power management unit for supplying a voltage and current to each element so that the video transmission and receiving apparatus is normally operated.

2. The apparatus of claim 1, further comprising a computer connection unit for controlling and managing the function and operation of the video transmission and receiving apparatus based on a unmanned or remote method.

3. The apparatus of claim 1, further comprising an option unit for diversifying and maximizing the functions of the video transmission and receiving apparatus.

4. The apparatus of claim 1, further comprising a security connector for transmitting a video signal in a security format.

5. The apparatus of claim 1, wherein said video transmission and receiving apparatus is connected by a connection apparatus separately from the radio communication instrument.

6. The apparatus of claim 1, wherein said video transmission and receiving apparatus is used integrally with the radio communication instrument.

7. In a video signal compression method of a video transmission and receiving apparatus, an improved video signal compression method of a video transmission and receiving apparatus, comprising:
a step for storing an inputted digital video data into a storing unit by the unit of a field or frame;
a step for computing the stored video data by a horizontal line of the field or frame, JPEG-compressing the number of the lines as one unit and storing the compressed data into another storing unit; and
a step for forming a process that a digital video data is JPEG-compressed and stored into a memory region as a loop and performing the loop until all line data in the selected field or frame are JPEG-compressed.

8. The method of claim 7, wherein said JPEG compression is performed by a first irregular function generation routine, and said first irregular function generation routine includes:
a step for sequentially or randomly varying a certain group of numeral digits at a certain speed;
a step for selecting a certain numeral digit from the group of the numeral digits when transferring a video through the video transmission and receiving apparatus; and
a step in which the number of the horizontal lines of the JPEG-compressed field or frame is determined based on a selected numeral digit.

9. A method for encrypting a JPEG-compressed signal in a video transmission and receiving apparatus includes:
a step for storing the JPEG compressed data into a storing unit by the field or frame in a sequence that the data is compressed and providing a serial number to each compression data;
a step for randomly a serial number of the compression data; and
a step for transferring a JPEG-compressed video data in accordance with a sequence of the changed serial number

10. The method of claim 9, wherein said step for changing the serial number of the compression data includes:
a step for forming a plurality of code variation tables having a serial number of the compressed data and a changed number corresponding to the serial number based on 1:1;
a step for randomly selecting one among the variation tables the video data is transmitted; and
a step for changing the sequence of the data compressed in a sequence that the data is formed in a corresponding table when selecting one among the variation tables.

11. A signal format used when transferring and receiving a video signal using a radio communication instrument, comprising:
a code for indicating a transmission start of a video data as a header of a signal format;
a code for indicating a variations state of a JPEG compression data;
a code for indicating a JPEG compression method;
a compression video data;
a code for indicating a data of other function; and
a recognizing code for indicating a completion of a video signal transmission.
